(19) United States
(12) Patent Application Publication
(10) Pub. No.: US 2012/0019490 A1
(43) Pub. Date: Jan. 26, 2012

(54) MODULAR LED DISPLAY STRUCTURE WITH CONNECTING EDGE BANDING TO CONNECT EACH OTHER

(76) Inventor: Hsien-Jung Huang, Taipei Hsien (TW)

(21) Appl. No.: 12/842,551

(22) Filed: Jul. 23, 2010

(51) Int. Cl. G09G 3/32; G06F 3/038

(52) U.S. Cl. 345/205; 345/83

(57) ABSTRACT

A modular LED (Light Emitting Diode) display structure includes full-color LED units to be arranged in a matrix on a flexible PCB, and plurality of protective plates to protect connection between the full-color LED units and the transmission line of the flexible PCB. Also, the edge of the display has a connecting edge banding with a hook to form a track thereunder. The hook can clip the track of another LED module plate for connection to develop a lager LED display. Moreover, by a hanger connecting to the connecting edge banding to simplify the suspending of the LED display. Furthermore, each full-color LED units has a driving chip to enhance the resolution of the LED display.

### BACKGROUND OF THE INVENTION

1. Field of the Invention

The present invention relates to a LED (Light Emitting Diode) display structure, and more particularly, to a LED display structure with a plurality of LED module plate connected each other to develop various sizes of LED display.

2. Related Art

Light plays a significant role for a very long time in human life. Accompanying with the constant progresses of science and technology, LED (Light Emitting Diode) has been invented in 1970s. With the advantages of compact size, long lifetime, low breakage, low power consumption, no heat radiation and no toxic pollution (such as mercury and etc.), comparing with conventional light sources, LED is now broadly utilized in our daily life.

Through the environment/economization policies driven by the governments around the world, LED is well-developed and applied to two major applications including display and illumination functions. Due to plenty of nonstop technology advancements, the conventional single-color LED is gradually unable to satisfy human's visual needs. Conventional large LED displays are constructed by LED matrixes with LED units arranged in lengthwise and transverse. The LED displays, which controlled by software, illuminate different lights to show desired texts or images.

If the size of the base plate of the single-one large LED display is huge, the manufacturing cost is increased. Also, it is hard to maintain or repair if some of the LED units are cracked. Therefore, the large LED display is formed by LED module plates now. However, the connection mechanism is complex which is not easy to assemble and carry.

### SUMMARY OF THE INVENTION

To solve the aforesaid problems of the prior art, the present invention provides a modular LED display structure with connecting edge banding to connect each other. The modular LED display of the present invention is easy to take and to assemble to develop a large led display.

Accordingly, the present invention discloses a LED display structure having a plurality of LED module plates connected each other. The LED module plates includes a flexible PCB (printed circuit board), a plurality of protective plates, a plurality of full-color LED units and at least one connecting edge banding. The full-color LED units are arranged on the flexible PCB to form a matrix and at least one transmission line connects thereof. The protective plates pasted on the back side of the flexible PCB corresponding to the full-color LED units to protect connection between the full-color LED units and the transmission line. Due to the full-color LED units have a driving chip, the resolution of the LED display is enhanced. Also, because the full-color LED units are pasted on a flexible PCB, the LED module plate is easy to carry by rolling.

On the other hand, the connecting edge banding is disposed on an edge of LED module plate. And the connecting edge banding includes a hook to form a track thereunder. The hook can only slide in another track along a lengthwise direction of the connecting edge banding when clipping to the track. Therefore, the LED module plate can connect to another LED module plate by the connecting edge bandings to form the large LED display. Furthermore, the present invention further includes a hanger connected to the connecting edge banding to suspend the LED module plate. Therefore, the LED display structure according to the present invention is easy to assemble to develop a large led display, and also achieves low cost and decreases labor hour for assembly.

The flexible PCB has a pair of power supply through holes to receive a supply voltage. The transmission line is arranged to-and-fro to connect the full-color LED units to divide the flexible PCB into two areas, which defined a positive area and a negative area. The pair of the power supply through holes attached in the positive area and the negative area respectively and each full-color LED unit is attached across the positive area and the negative area. Therefore, it is easy to supply power for the full-color LED units of the LED module plates. Even several LED module plates are connected together by connecting edge bandings, the present invention may simply utilize a conductive connecting element to connect all the power supply through holes of the LED module plates respectively.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein below for illustration only, and thus is not limitative of the present invention, and wherein:

FIG. 1 is a respective view for the LED module plate of the present invention;

FIG. 2 is a schematic view for the LED module plate of the present invention;

FIG. 3 is a explosive view for the LED module plate of the present invention;

FIG. 4 shows the LED module plates connected to each other according to the present invention;

FIG. 5 shows the details of the full-color LED units according to the present invention;

FIGS. 6A and 6B are schematic views of the LED module plates according to the present invention, illustrating using the positive area and the negative area for the power supply through holes; and

FIGS. 7A and 7B are schematic views of the LED display structure according to the present invention, illustrating using a conductive connecting element to connect the power supply through holes of the LED module plates.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description refers to the same or the like parts.

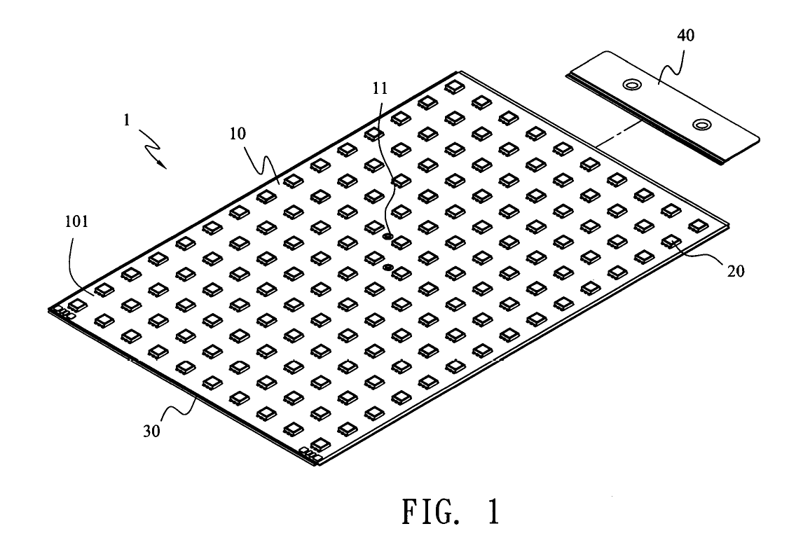

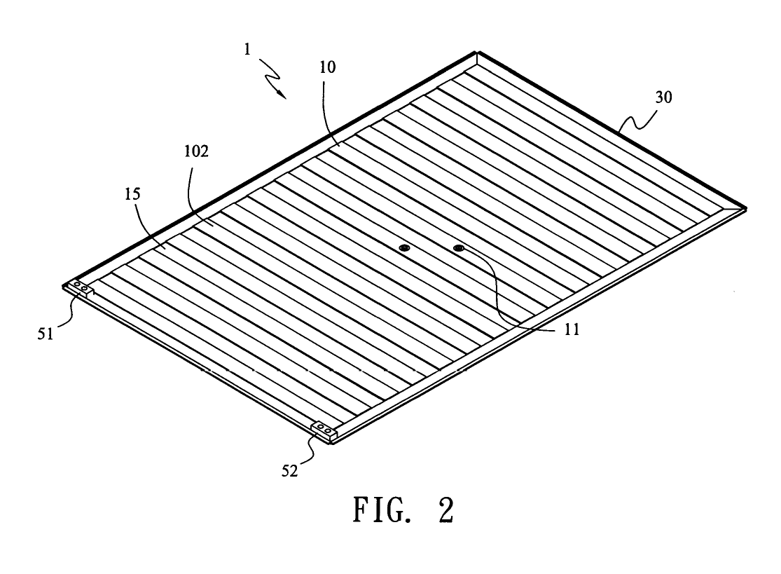

Please refer to FIG. 1, which is a respective view for the LED module plate of the present invention to show the front side of the LED module plate. Please refer to FIG. 2, which is a schematic view for the LED module plate of the present invention to show the back side of the LED module plate.

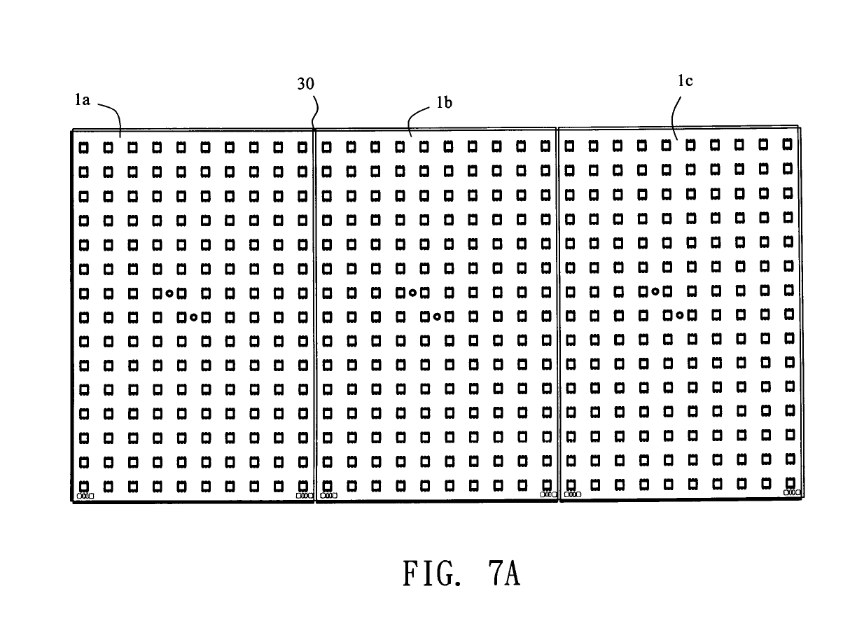

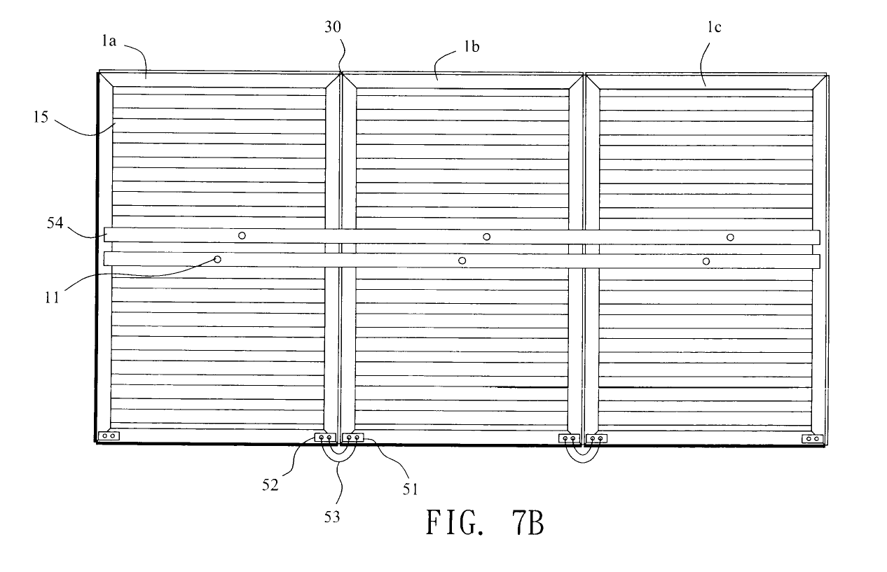

The LED (Light Emitting Diode) display structure having a plurality of LED module plates 1 which can be connected each other, also refer to FIG. 7A. The LED module plates 1 includes a flexible PCB (printed circuit board) 10, a plurality of protective plates 15, a plurality of full-color LED units 20 and connecting edge bandings 30. The flexible PCB 10 includes a first side 101 and a second side 102. The full-color LED units 20 are mounted on the first side 102 of the flexible PCB 10. The connecting edge bandings 30 disposed on the four edges of the LED module plates 1 to connect the adjacent LED module plates 1 to form a larger LED display. One of the connecting edge bandings 30 has a hanger 40 or clips the hanger 40. Therefore, it is easy to suspend the LED module plate 1.

The flexible PCB 10 is disposed a pair of power supply through holes 11, which pass through thereon, to receive a supply voltage. The second side 102 of the flexible PCB 10 has the protective plates 15, an input port 51 and an output port 52, please refer to FIG. 2. The input port 51 is connected to the full-color LED units 20 to receive a controlling signal and transmit to the full-color LED units 20. The output port 52 is also connected to the full-color LED units 20 to receive the controlling signal and transmit to the adjacent LED module plate 1. Therefore, the input port 51 and the output port 52 of the LED module plates 1 have the same specification to establish communication between of the LED module plates 1, also refer to FIG. 7.

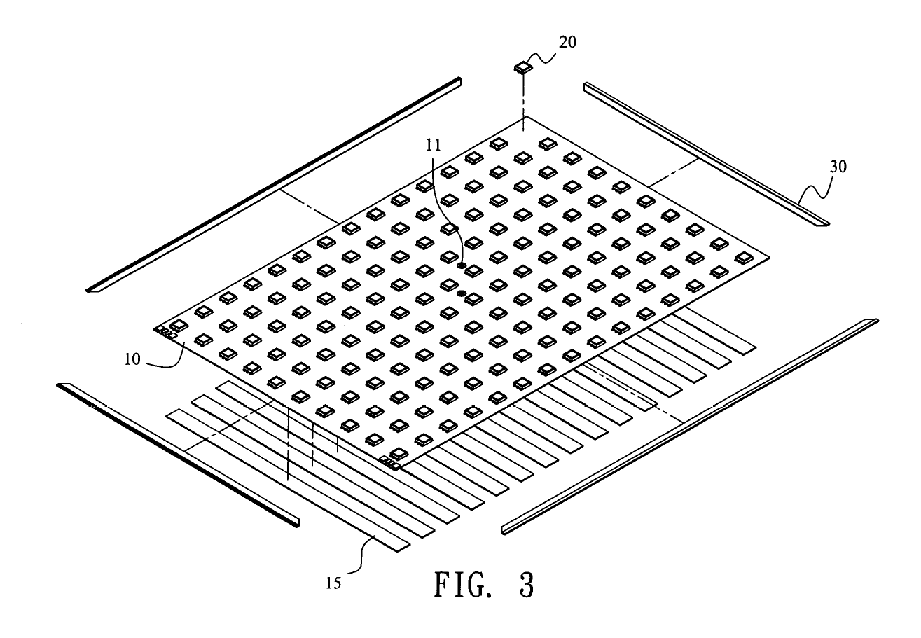

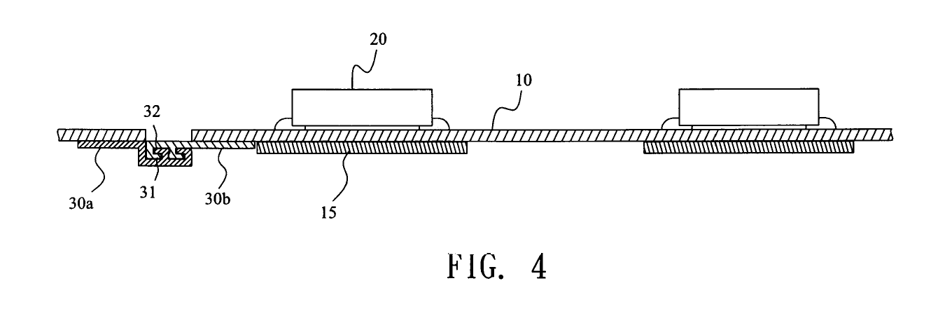

Please refer to FIG. 3, the full-color LED units 20 are disposed on the first side 101 of the flexible PCB 10, preferably the flexible PCB 10 has at least one transmission line 12 to connect to the input port 51, also to the output port 52, shown in FIGS. 7A and 7B. The full-color LED units 20 are RGB LED units with driving circuits respective to each colors. The full-color LED units 20 are disposed on the first side 101 of the flexible PCB 10, and the transmission line 12 connects the full-color LED units 20 to the input port 51 and the output port 52. Therefore, the full-color LED units 20 are connected to the transmission lines 22 to form a loop to receive the controlling signal by the input port 51. The protective plates 15, which is made of plastic, are pasted on the second side 102 of the flexible PCB 10 corresponding to the full-color LED units 10. The protective plate 15 is slightly border than the full-color LED unit 10, see FIG. 4, to protect connection between the full-color LED units 10 and the transmission line 12. As a result, even the LED module plates 1 is rolled for carrying or the external force, the connection between the full-color LED units 20 and the flexible PCB 10 or the transmission line 12 could be protected without damage or crack.

Please refer to FIG. 4, which shows the LED module plates 1 connected to each other according to the present invention. The connecting edge bandings 30 are disposed on the edges of the flexible PCB 10 by pasting, pressing, or melting. Each connecting edge banding 30 includes a hook 31 to form a track 32 thereunder, which is parallel to the edge. Therefore, the hook 31 of the right connecting edge banding 30b clips the track 32 of the left connecting edge banding 30a to connect the two adjacent LED module plates 1. Due to the hook-like and track structure, the hook 31 only can slide in the track 32 along the lengthwise direction of the connecting edge banding 30. Therefore, the connection relationship between the LED module plates 1 by the connecting edge bandings 30 is firm. As shown in FIG. 4, each of the connecting edge bandings 30a, 30b has two hooks 31 and two tracks 32 to make the connection be firmer.

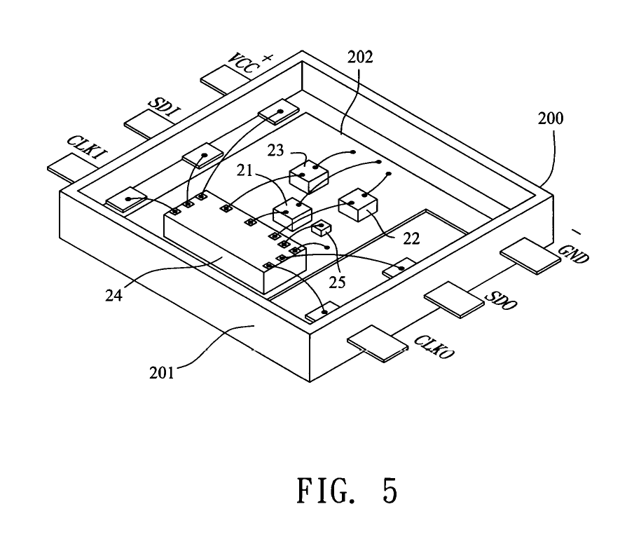

Moreover, the connecting edge bandings 30 are disposed on the second side 102 of the flexible PCB 10. When the LED module plates 1 connected to each other by the connecting edge bandings 30, the connecting edge bandings 30 would not protrude from surrounding to affect appearance. Please refer to FIG. 5, which shows the details of the full-color LED units according to the present invention.

The full-color LED units 20 includes a red LED chip 21, a green LED chip 22, a blue LED chip 23, and a driving chip 24, which are carried by a carrier 201. The full-color LED units 20 also includes a power terminal VCC, a ground terminal GND, a clock input terminal CLKI, a clock output terminal CLKO, a serial data input terminal SDI, and a serial data output terminal SDO, which are extended outside the carrier 201. The ground terminal GND also extends inside the carrier 201 to form a square extension portion 202. And the red LED chip 21, the green LED chip 22, the blue LED chip 23, and the driving chip 24 are disposed on the extension portion 202.

The red LED chip 21, the green LED chip 22, the blue LED chip 23 have a first pole and a second pole respectively. The first poles of the red LED chip 21, the green LED chip 22, the blue LED chip 23 connect to the extension portion 202, and the second poles of the red LED chip 21, the green LED chip 22, the blue LED chip 23 connect to the driving chip 24 by wire-bonding. And the driving chip 24 also connects to the power terminal VCC, the ground terminal GND, the clock input terminal CLKI, the clock output terminal CLKO, the serial data input terminal SDI, and the serial data output terminal SDO by wire-bonding. Therefore, due to each full-color LED unit 20 has driving mechanism, the density of the arrangement for the full-color LED units 20 pasted on the LED module plate 1 is increased.

To control the supply voltage more precisely in a suitable range, the full-color LED unit 20 further includes a current limiting resistor 25. The current limiting resistor 25 is electrically connected to the driving chip 24 by wire-bonding. The current limiting resistor 25 may be a double-sided chip resistor. When the current limiting resistor 25 is pasted on the extension portion 201, the current limiting resistor 25 will be electrically connected to the ground terminal GND. Therefore, the full-color LED unit 20 may operate in constant current mode to protect the chips.

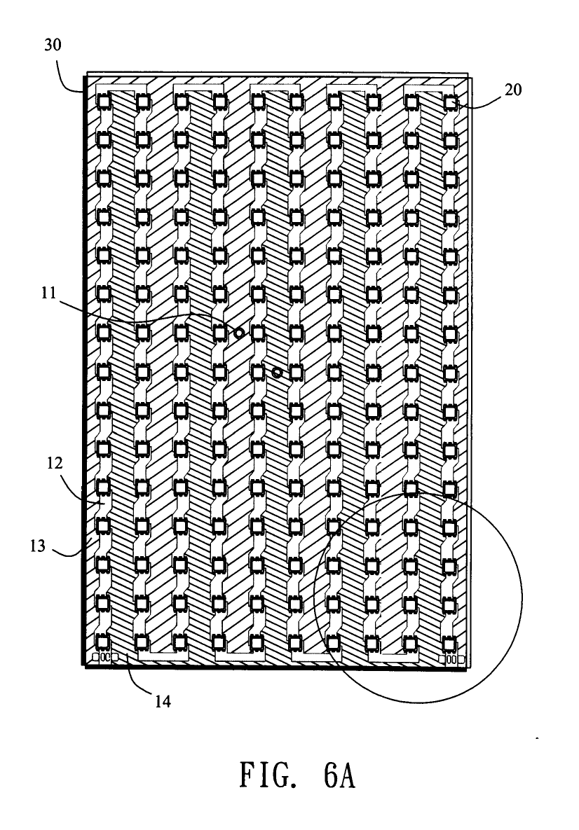

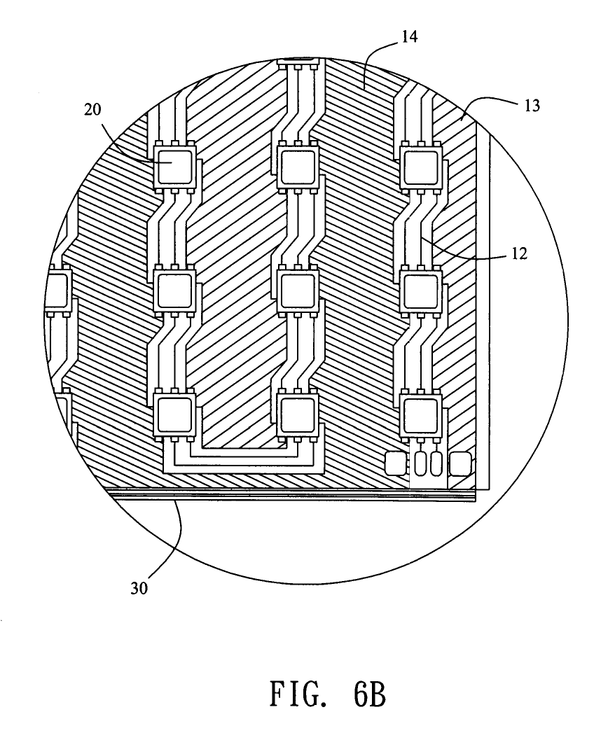

Please see FIGS. 6A and 6B, which are schematic views of the LED module plates 1 according to the present invention and illustrates using the positive area 13 and the negative area 14 for the power supply through holes 11.

The full-color LED units 20 are arranged on the flexible PCB 10 in a matrix, and the transmission line 12 is arranged to-and-fro to connect all the full-color LED units 20. The transmission line 12 would divide the flexible PCB 10 into two areas, which defined a positive area 13 and a negative area 14. Therefore, each full-color LED unit 20 is attached across the positive area 13 and the negative area 14. The pair of the power supply through holes 11 are attached in the positive area 13 and the negative area 14 respectively. When the supply voltage is supplied to the power supply through holes 11, all the full-color LED units 20 can receive the supply voltage to illuminate. Due to the supply voltage is supplied from the middle portion of the flexible PCB 10, not the endpoint of the transmission line 12, i.e. the input port 51 and the output port 52, the chromatic aberration caused by the delay of power signal transmission will be improved.

FIGS. 7A and 7B are schematic views of the LED display structure according to the present invention, illustrating using a conductive connecting element to connect the power supply through holes of the LED module plates.

The LED display structure is constructed of three LED module plates 1a, 1b, 1c by connecting edge banding 30. And the input port 51 and the output port 52 is connected by a connecting line 53. Therefore, the controlling signal is inputted from the input port 51 of the LED module plate 1a, and out put from output port 52 of the LED module plate la through the transmission line 12. Then the controlling signal is transmitted to the input port 51 of the LED module plate 1b through connecting line 53 and go on. Hence, it's not need to provide the controlling signal for each LED module plate 1a, 1b, 1c. Furthermore, a pair of conductive connecting elements 54, such as made of copper, are disposed to connect the power supply through holes 11 of the LED module plates 1a, 1b, 1c, which located on the same areas of the flexible PCB 10.

Through the connecting edge banding 30 disclosed the present invention, the labor hour to assemble the LED module plates 1 to develop a larger LED display is decreased. When one of the LED units 20 is failure or breakdown, it is easy to repair by replacing a new modular LED module plates 1. The hanger 40 is also connected by the connecting edge banding 30. The LED display is suspended without complicated process. Moreover, the full-color LED units 20 are disposed on the flexible PCB 10, the LED module plate 1 or the assembled LED display is flexible and is enabled to roll. The package and transportation is more efficient. Also, due to each full-color LED unit 20 has driving mechanism, the density of the arrangement for the full-color LED units 20 pasted on the LED module plate 1 is increased. The supply voltage is supplied from the middle portion of the flexible PCB 10, not the endpoint of the transmission line 12, i.e. the input port 51 and the output port 52, the chromatic aberration caused by the delay of power signal transmission will be improved.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. A LED (Light Emitting Diode) display structure having a plurality of LED module plates connected each other, each LED module plate comprising:
a flexible PCB (printed circuit board), with a first side and a second side, and having at least one transmission line on first side and a pair of power supply through holes to receive a supply voltage;
a plurality of full-color LED units, disposed on the first side of the flexible PCB, and connected electrically to the transmission line of the flexible PCB and received the supply voltage;
a plurality of protective plates, pasted on the second side of the flexible PCB corresponding to the full-color LED units, wherein each protective plate is slightly border than the full-color LED unit to protect connection between the full-color LED units and the transmission line; and
at least one connecting edge banding, disposed on an edge of one of the flexible PCB, comprising a hook to form a track thereunder; wherein the hook clips the track of another LED module plate for connection.

2. The LED display structure of claim 1, wherein the second side of the flexible PCB comprising:
at least one input port, electrically connected to the transmission line to receive a controlling signal and transmit to the full-color LED units; and
an output port, electrically connected to the transmission line to receive the controlling signal and transmit to another LED module plate.

3. The LED display structure of claim 1, wherein the full-color LED unit includes a red LEC chip, a green LED chip, a blue LED chip and a driving chip.

4. The LED display structure of claim 3, wherein the full-color PCB further includes a current limiting resistor electrically connected to the driving chip.

5. The LED display structure of claim 1, wherein the hook only slide in the track along a lengthwise direction of the connecting edge banding.

6. The LED display structure of claim 1, wherein the protective plate is made of plastic.

7. The LED display structure of claim 1, further comprises a hanger connected to the connecting edge banding to suspend the LED module plate.

8. The LED display structure of claim 1, wherein the full-color LED units are arranged on the flexible PCB in a matrix, and the transmission line is arranged to-and-fro to connect the full-color LED units.

9. The LED display structure of claim 8, wherein the transmission line divides the flexible PCB into two areas, which defined a positive area and a negative area; wherein each full-color LED unit is attached across the positive area and the negative area.

10. The LED display structure of claim 9, wherein the pair of the power supply through holes attached in the positive area and the negative area respectively.

11. The LED display structure of claim 10, further comprises a conductive connecting element to connect the power supply through holes of the LED module plates, which located on the same areas of the flexible PCB.

12. A LED (Light Emitting Diode) module plate, comprising:
a flexible PCB (printed circuit board), with a first side and a second side, and having at least one transmission line on first side and a pair of power supply through holes to receive a supply voltage;
a plurality of full-color LED units, disposed on the first side of the flexible PCB in a matrix, and connected electrically to the transmission line of the flexible PCB and received the supply voltage; and
wherein the transmission line is arranged to-and-fro to connect the full-color LED units to divide the flexible PCB into two areas, which defined a positive area and a negative area;
wherein the pair of the power supply through holes attached in the positive area and the negative area respectively and each full-color LED unit is attached across the positive area and the negative area;
a plurality of protective plates, pasted on the second side of the flexible PCB corresponding to the full-color LED units, wherein each protective plate is slightly border than the full-color LED unit to protect connection between the full-color LED units and the trace.

13. The LED module plate of claim 12, wherein the second side of the flexible PCB comprising:
at least one input port, electrically connected to the transmission line to receive a controlling signal and transmit to the full-color LED units; and
an output port, electrically connected to the transmission line to receive the controlling signal and transmit to another LED module plate.

14. The LED module plate of claim 12, wherein the full-color LED unit includes a red LEC chip, a green LED chip, a blue LED chip and a driving chip.

15. The LED module plate of claim 14, wherein the full-color PCB further includes a current limiting resistor electrically connected to the driving chip.

16. The LED module plate of claim 12, wherein the protective plate is made of plastic.
